(19) United States
(12) Patent Application Publication
(10) Pub. No.: US 2018/0051180 A1
(43) Pub. Date: Feb. 22, 2018

(54) Reactive Coating Method for Deposition of Insoluble Flame Retardant Using a Water-Borne Coating Procedure

(71) Applicant: The Texas A&M University System, College Station, TX (US)

(72) Inventors: Jaime C. Grunlan, College Station, TX (US); Marcus Leistner, College Station, TX (US)

(73) Assignee: The Texas A&M University System, College Station, TX (US)

(21) Appl. No.: 15/558,457

(22) PCT Filed: Mar. 21, 2016
(86) PCT No.: PCT/US2016/023464

§ 371 Date: Sep. 14, 2017

Related U.S. Application Data
(60) Provisional application No. 62/136,015, filed on Mar. 20, 2015.

(51) Int. Cl. C09D 5/18; C09D 7/12; C09D 185/02; C08K 5/521; C08K 5/3492; D06M 15/31

(52) U.S. Cl. CPC C09D 5/18; C09D 7/1233; C09D 185/02; D06M 2200/30; C08K 5/34922; D06M 15/31; C08K 5/521

(57) ABSTRACT

A method includes coating a substrate to provide a flame resistant substrate. In an embodiment, the method includes exposing the substrate to a cationic solution to produce a cationic layer deposited on the substrate. The cationic solution comprises cationic materials. The cationic materials comprise a melamine. The method further includes exposing the cationic layer to an anionic solution to produce an anionic layer deposited on the cationic layer to produce a layer comprising the anionic layer and the cationic layer. The anionic solution comprises a phosphated molecule.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE DISCLOSURE

### Field of the Disclosure

This disclosure relates to the field of coatings and more specifically to the field of flame retardant coatings for substrates of foam or fabric.

### Background of the Disclosure

Fire-related occurrences have caused widespread property damage and injuries. It is well known that a wide range of commonly used materials are flammable. To reduce the hazards from such flammable materials, flame retardants have been developed. Such flame retardants include halogenated materials. Halogenated materials typically include brominated compounds and chlorinated compounds. Drawbacks to such halogenated materials include the potential for harm to the environment and humans. For instance, such halogenated materials may form toxins. Other drawbacks include a lack of durability that may be typical in some instances to the brominated compounds.

The use of nanoparticles has been developed to overcome such drawbacks. However, drawbacks to use of nanoparticles include increased processing viscosity and modulus of the final polymer material, such as foam or fabric. Further drawbacks include inadequate flame suppression and melt-dripping.

Consequently, there is a need for an improved fire retardant polymer material. There is a further need for improved fire retardant coatings for foam, fabric and other substrate materials.

### BRIEF SUMMARY OF SOME OF THE PREFERRED EMBODIMENTS

In an embodiment, these and other needs in the art are addressed by a method for coating a substrate to provide a flame resistant substrate. The method includes exposing the substrate to a cationic solution to produce a cationic layer deposited on the substrate. The cationic solution comprises cationic materials. The cationic materials comprise a melamine. The method further includes exposing the cationic layer to an anionic solution to produce an anionic layer deposited on the cationic layer to produce a layer comprising the anionic layer and the cationic layer. The anionic solution comprises a phosphated molecule.

In embodiments, these and other needs in the art are addressed by a method for coating a substrate to provide a flame resistant substrate. The method includes exposing the substrate to an anionic solution to produce an anionic layer deposited on the substrate. The anionic solution comprises a phosphated molecule. The method further includes exposing the anionic layer to a cationic solution to produce a cationic layer deposited on the anionic layer to produce a layer comprising the anionic layer and the cationic layer. The cationic solution comprises cationic materials. The cationic materials comprise a melamine.

The foregoing has outlined rather broadly the features and technical advantages of the present disclosure in order that the detailed description of the disclosure that follows may be better understood. Additional features and advantages of the disclosure will be described hereinafter that form the subject of the claims of the disclosure. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### BRIEF DESCRIPTION OF THE DRAWINGS

For a detailed description of the preferred embodiments of the disclosure, reference will now be made to the accompanying drawings in which:

FIG. 1 illustrates a coated substrate embodiment;

FIG. 2 illustrates an embodiment with bilayers of layerable materials and additives;

FIG. 3 illustrates an embodiment with alternating layers of layerable materials and additives;

FIG. 4 illustrates an embodiment with bilayers of layerable materials and additives; and

FIG. 5 illustrates an embodiment of a coating with a quadlayer and a primer layer.

### DETAILED DESCRIPTION OF THE PREFERRED EMBODIMENTS

In an embodiment, a multilayer thin film coating method provides a substrate with a fire retardant coating by alternately depositing positive and negative charged layers on the substrate. Each pair of positive and negative layers comprises a layer. In embodiments, the multilayer thin film coating method produces any number of desired layers on substrates such as bilayers, trilayers, quadlayers, pentalayers, and the like. The positive and negative layers may have any desired thickness. In embodiments, each layer is between about 1 nanometer and about 100 nanometers thick. In an embodiment, the fire retardant coating is between about 10 nanometers and about 1,000 nanometers thick, alternatively between about 40 nanometers and about 500 nanometers thick.

Any desirable substrate may be coated with the multilayer thin film coating method. In embodiments, the substrate includes foam, fabric, leather, vinyl compounds, plastic, glass, ceramic, metal, wood, carpet, hook and loop fasteners, non-foam padding, lapis, ducts, yarn, or any combinations thereof. Any desirable foam may be used as the substrate. Without limitation, examples of suitable foams include polyurethane foam and polystyrene foam. The fabric used may include any desirable type of fabric. Without limitation, examples of suitable fabric include wool; linen; cotton (including blends with nylon, polyester, and the like); fabric formed from cellulosic yarn, fabric formed from synthetic yarn, or any combinations thereof (e.g., nylon and polyester fabric, polyester and cotton fabric, and the like); or any combinations thereof. In an embodiment, the substrate includes hook and loop fasteners (i.e., VELCRO®, which is a registered trademark of Velcro Industries, B.V.). In some embodiments, the substrate is a carpet or the like. It is to be understood that a carpet refers to a woven floor covering having an upper pile layer attached to a backing. In an embodiment, the substrate is a duct or a system of ducts (e.g., ductwork). In some embodiments, the substrate is wood. In embodiments, the wood includes wood products such as particle board. Without limitation, an example of wood is balsa wood. Non-foam padding refers to material that provides cushion against contact and that does not include foam. Without limitation, examples of non-foam padding include cotton, feathers, and the like. Any desirable yarn may be used. In an embodiment, yarns include fabrics comprising yarns formed from synthetic polymers. Without limitation, examples of yarns formed from synthetic polymers include polyester, polyamides, para-aramids, polyethylene terephthalate, nylon 6-6, nylon 6, or any combinations thereof. The substrate may be positively charged, negatively charged, or neutral.

The negative charged (anionic) layers comprise layerable materials. The layerable materials include anionic polymers, colloidal particles, phosphated molecules, sulfated molecules, boronic acid, boron containing acids, or any combinations thereof. Without limitation, examples of suitable anionic polymers include branched polystyrene sulfonate (PSS), polymethacrylic acid (PMAA), polyacrylic acid (PAA), or any combinations thereof. In addition, without limitation, colloidal particles include organic and/or inorganic materials. Further, without limitation, examples of colloidal particles include clays, colloidal silica, inorganic hydroxides, silicon based polymers, polyoligomeric silsesquioxane, carbon nanotubes, graphene, or any combinations thereof. Any type of clay suitable for use in an anionic solution may be used. Without limitation, examples of suitable clays include sodium montmorillonite, hectorite, saponite, Wyoming bentonite, halloysite, vermiculite, or any combinations thereof. In an embodiment, the clay is sodium montmorillonite. Any inorganic hydroxide that may provide flame retardancy may be used. In an embodiment, the inorganic hydroxide includes aluminum hydroxide, magnesium hydroxide, or any combinations thereof. Phosphated molecules refer to molecules with a phosphate ion. Examples of suitable phosphate molecules include polysodium phosphate (PSP), ammonium phosphate, ammonium polyphosphate, sodium hexametaphosphate, or any combinations thereof. Sulfated molecules refer to molecules with a sulfate ion. Examples of suitable sulfated molecules include ammonium sulfate, sodium sulfate, polyethylene glycol sulfate, poly vinyl sulfonic acid, or any combinations thereof. Any boronic acid suitable for use in an anionic layer may be used. In an embodiment, the boronic acid is 2-methylpropylboronic acid, 2-hydroxy-3-methylphenyl boronic acid, polymer-bound boronic acid, or any combinations thereof. Any boron containing acid suitable for use in an anionic layer may be used. In an embodiment, the boron containing acid is boric acid. In embodiments, any salt suitable for use in an anionic layer may be used. In embodiments, anionic materials may include a phosphate-rich salt, a sulfate-rich salt, or any combinations thereof. In alternative embodiments, layerable materials are neutral. In embodiments, at least one layerable material comprises a phosphated molecule.

The positive charge (cationic) layers comprise cationic materials. The cationic materials comprise polymers, colloidal particles, nanoparticles, nitrogen-rich molecules, or any combinations thereof. The polymers include cationic polymers, polymers with hydrogen bonding, or any combinations thereof. Without limitation, examples of suitable cationic polymers include branched polyethylenimine (BPEI), cationic polyacrylamide, cationic poly diallyldimethyl ammonium chloride (PDDA), poly (melamine-co-formaldehyde), polymelamine, copolymers of polymelamine, polyvinylpyridine, copolymers of polyvinylpyridine, or any combinations thereof. Without limitation, examples of suitable polymers with hydrogen bonding include polyethylene oxide, polyallylamine, or any combinations thereof. In addition, without limitation, colloidal particles include organic and/or inorganic materials. Further, without limitation, examples of colloidal particles include clays, layered double hydroxides (LDH), inorganic hydroxides, silicon based polymers, polyoligomeric silsesquioxane, carbon nanotubes, graphene, or any combinations thereof. Without limitation, examples of suitable layered double hydroxides include hydrotalcite, magnesium LDH, aluminum LDH, or any combinations thereof. Without limitation, an example of a nitrogen-rich molecule is melamine. In embodiments, cationic materials may include a phosphate-rich salt, a sulfate-rich salt, or any combinations thereof. In alternative embodiments, cationic materials are neutral. In an embodiment, at least one cationic material is melamine.

The melamine includes any melamine compound soluble in an aqueous solution. In embodiments, the melamine is any water soluble form of melamine. Without limitation, examples of melamine include melamine salts, melamine hydrochloric acid, or any combinations thereof. Melamine salts may include any water soluble salts of melamine. In an embodiment, melamine salts include melamine acetate, melamine monoacetate, melamine hydrochloride, or any combinations thereof.

In an embodiment, the active flame retardant ingredient is melamine polyphosphate, which is insoluble in water as well as organic solvents. The multilayer thin film coating method provides a procedure to deposit such flame retardant in a layer-by-layer process without using solvents or expensive coating procedures and conditions. In embodiments, when paired with any polycation (such as chemicals with synergistic effects), a polyphosphate may be deposited in alternative layers. In an embodiment, the polyions are dissolved in water or an appropriate solvent. The multilayer thin film coating method includes a reaction that forms melamine polyphosphate during the deposition on the substrate (e.g., fibers in a fabric). The melamine polyphosphate formation may be achieved by adding melamine to the aqueous solution containing the polycation. Without limitation, the multilayer thin film coating method does not adversely affect polymer properties, and a matrix polymer for the active flame retardant is not needed.

Moreover, in some embodiments, the active ingredient of the coating (such as melamine polyphosphate) may not be applied as a coating itself because of insolubility and non-reactivity. In the multilayer thin film coating method, an on-the-substrate formation of melamine polyphosphate by a chemical reaction of a water-soluble melamine salt (such as melamine hydrochloride) with a polyphosphate (such as ammonium polyphosphate or sodium hexametaphosphate) is accomplished. In embodiments, the multilayer thin film coating method purposefully uses competitive reactions. The polyphosphate is reacting with both the polycation (such as chitosan) and the melamine at about the same time. Such reaction may lead to complexation of polyanion and polycation, which may provide for the deposition of the coating onto the substrate as well as the formation of melamine polyphosphate, which is the active flame retardant.

The coated substrate may have any amount of nanocoating suitable to reduce or prevent flammability. In embodiments, the coated substrate has between about 1.0 wt. % and about 99.0 wt. % nanocoating, alternatively between about 1.0 wt. % and about 25.0 wt. % nanocoating, further alternatively between about 5.0 wt. % and about 25.0 wt. %, and alternatively between about 5.0 wt. % and about 12.5 wt. % nanocoating. Without limitation, the wt. % of coating desired may depend upon the substrate. Further, without limitation, different substrates may have different wt. % of coating to reduce or prevent flammability. For instance, embodiments include a cotton substrate having a nanocoating wt. % from about 1 wt. % to about 30 wt. %, and alternatively from about 5 wt. % to about 25 wt. %, and further alternatively from about 5 wt. % to about 20 wt. %.

In embodiments, the positive, negative, and/or neutral layers are deposited on the substrate by any suitable method. In embodiments, the suitable method includes any suitable water-based coating technology. Embodiments include depositing the layers on the substrate by any suitable liquid deposition method. Without limitation, examples of suitable methods include bath coating, spray coating, slot coating, spin coating, curtain coating, gravure coating, reverse roll coating, knife over roll (i.e., gap) coating, metering (Meyer) rod coating, air knife coating, or any combinations thereof. Bath coating includes immersion or dip in an aqueous solution. In an embodiment, the coating is deposited by bath in an aqueous solution. In other embodiments, the coating is deposited by spray of an aqueous solution.

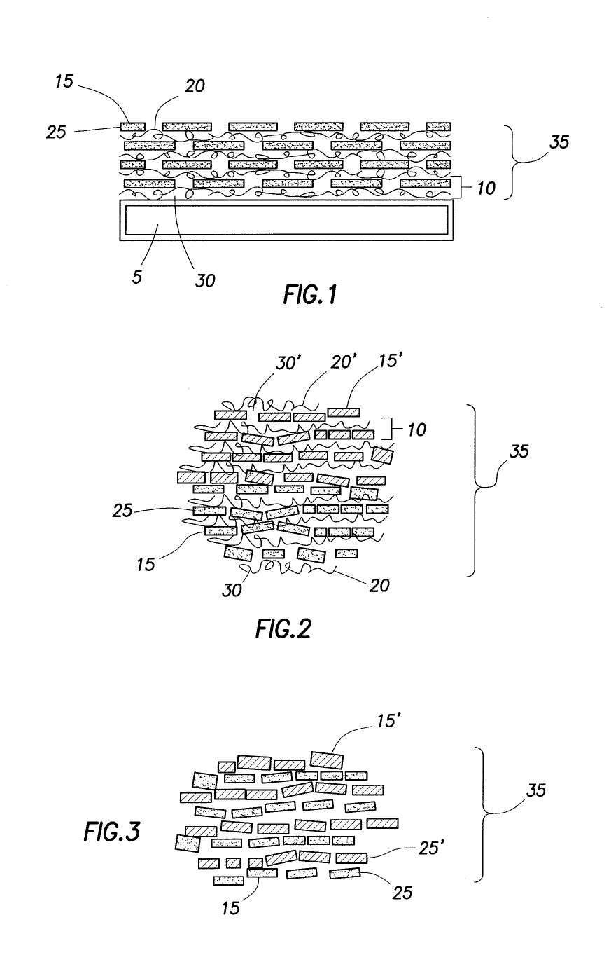

FIG. 1 illustrates an embodiment of a substrate 5 with a coating 35 of multiple bilayers 10. In an embodiment to produce the coated substrate 5 shown in FIG. 1, the multilayer thin film coating method includes exposing substrate 5 to cationic molecules in a cationic mixture to produce cationic layer 30 on substrate 5. The cationic mixture contains cationic materials 20. In such an embodiment, the substrate 5 is negatively charged or neutral. The cationic mixture includes an aqueous solution of the cationic materials 20. The aqueous solution may be prepared by any suitable method. In embodiments, the aqueous solution includes the cationic materials 20 and water. In other embodiments, cationic materials 20 may be dissolved in a mixed solvent, in which one of the solvents is water and the other solvent is miscible with water (e.g., water, ethanol, methanol, and the like). The solution may also contain colloidal particles in combination with polymers or alone, if positively charged. Any suitable water may be used. In embodiments, the water is deionized water. In some embodiments, the aqueous solution may include from about 0.01 wt. % cationic materials 20 to about 10.0 wt. % cationic materials 20, alternatively from about 0.8 wt. % cationic materials 20 to about 1.5 wt. % cationic materials 20, and alternatively from about 0.05 wt. % cationic materials 20 to about 1.50 wt. % cationic materials 20, and further alternatively from about 0.01 wt. % cationic materials 20 to about 1.00 wt. % cationic materials 20. In embodiments, the substrate 5 may be exposed to the cationic mixture for any suitable period of time to produce the cationic layer 30. In embodiments, the substrate 5 is exposed to the cationic mixture from about 1 second to about 20 minutes, alternatively from about 1 second to about 200 seconds, and alternatively from about 10 seconds to about 200 seconds. Without being limited by theory, the exposure time of substrate 5 to the cationic mixture and the concentration of cationic materials 20 in the cationic mixture affect the thickness of the cationic layer 30. For instance, the higher the concentration of the cationic materials 20 and the longer the exposure time, the thicker the cationic layer 30 produced by the multilayer thin film coating method.

In embodiments, after formation of cationic layer 30, the multilayer thin film coating method includes removing substrate 5 with the produced cationic layer 30 from the cationic mixture and then exposing substrate 5 with cationic layer 30 to anionic molecules in an anionic mixture to produce anionic layer 25 on cationic layer 30 and thereby form bilayer 10. The anionic mixture contains the layerable materials 15. Without being limited by theory, the positive cationic layer 30 attracts the anionic molecules to form the cationic-anionic pair of bilayer 10. The anionic mixture includes an aqueous solution of the layerable materials 15. The aqueous solution may be prepared by any suitable method. In embodiments, the aqueous solution includes the layerable materials 15 and water. Layerable materials 15 may also be dissolved in a mixed solvent, in which one of the solvents is water and the other solvent is miscible with water (e.g., water, ethanol, methanol, and the like). Combinations of anionic polymers and colloidal particles may be present in the aqueous solution. Any suitable water may be used. In embodiments, the water is deionized water. In some embodiments, the aqueous solution may include from about 0.05 wt. % layerable materials 15 to about 10.0 wt. % layerable materials 15, alternatively from about 1.0 wt. % layerable materials 15 to about 4.00 wt. % layerable materials 15. In embodiments, substrate 5 with cationic layer 30 may be exposed to the anionic mixture for any suitable period of time to produce anionic layer 25. In embodiments, substrate 5 with cationic layer 30 is exposed to the anionic mixture from about 1 second to about 20 minutes, alternatively from about 1 second to about 200 seconds, and alternatively from about 10 seconds to about 200 seconds. Without being limited by theory, the exposure time of substrate 5 with cationic layer 30 to the anionic mixture and the concentration of layerable materials 15 in the anionic mixture affect the thickness of anionic layer 25. For instance, the higher the concentration of the layerable materials 15 and the longer the exposure time, the thicker the anionic layer 25 produced by the multilayer thin film coating method. Substrate 5 with bilayer 10 is then removed from the anionic mixture. In embodiments, the exposure steps are repeated with substrate 5 having bilayer 10 continuously exposed to the cationic mixture and then the anionic mixture to produce multiple bilayers 10 as shown in FIG. 1. The repeated exposure to the cationic mixture and then the anionic mixture may continue until the desired number of bilayers 10 is produced. It is to be understood that the same method is used to produce trilayers, quadlayers, and the like.

In an embodiment as shown in FIG. 5, coating 35 has quadlayer 100 having cationic layer 30 with anionic layer 25 on cationic layer 30, a second cationic layer 30″ on anionic layer 25, and a second anionic layer 25″ on second cationic layer 30″. As shown, quadlayer 100 has anionic layer 25 having layerable materials 15, anionic layer 25″ having layerable materials 15″, cationic layer 30 having cationic materials 20, and cationic layer 30″ having cationic materials 20″. In embodiments as shown in FIG. 5, coating 35 also comprises primer layer 105. Primer layer 105 is disposed between substrate 5 and cationic layer 30 of quadlayer 100. Primer layer 105 may have any number of layers. The layer of primer layer 105 proximate to substrate 5 has a charge with an attraction to substrate 5, and the layer of primer layer 105 proximate to cationic layer 30 has a charge with an attraction to cationic layer 30. In embodiments as shown in FIG. 5, primer layer 105 is a bilayer having a first primer layer 110 and a second primer layer 115. In such embodiments, first primer layer 110 is a cationic layer (or alternatively neutral) comprising first primer layer materials 120, and second primer layer 115 is an anionic layer comprising second primer layer materials 125. First primer layer materials 120 comprise cationic materials. In an embodiment, first primer layer materials 120 comprise melamine. Second primer layer materials 125 comprise layerable materials. In an embodiment, second primer layer materials 125 comprise phosphated molecules. In other embodiments (not shown), primer layer 105 has more than one bilayer.

It is to be understood that the multilayer thin film coating method is not limited to exposure to a cationic mixture followed by an anionic mixture. In embodiments in which substrate 5 is positively charged, the multilayer thin film coating method includes exposing substrate 5 to the anionic mixture followed by exposure to the cationic mixture. In such embodiment (not illustrated), anionic layer 25 is deposited on substrate 5 with cationic layer 30 deposited on anionic layer 25 to produce bilayer 10 with the steps repeated until coating 35 has the desired thickness. In embodiments in which substrate 5 has a neutral charge, the multilayer thin film coating method may include beginning with exposure to the cationic mixture followed by exposure to the anionic mixture or may include beginning with exposure to the anionic mixture followed by exposure to the cationic mixture.

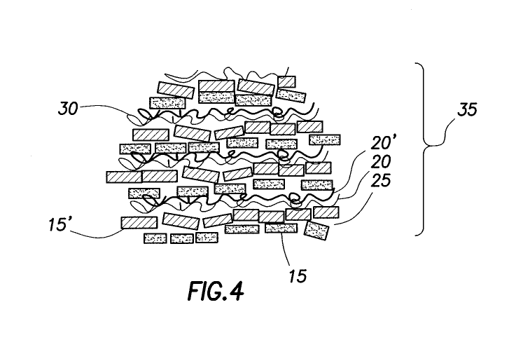

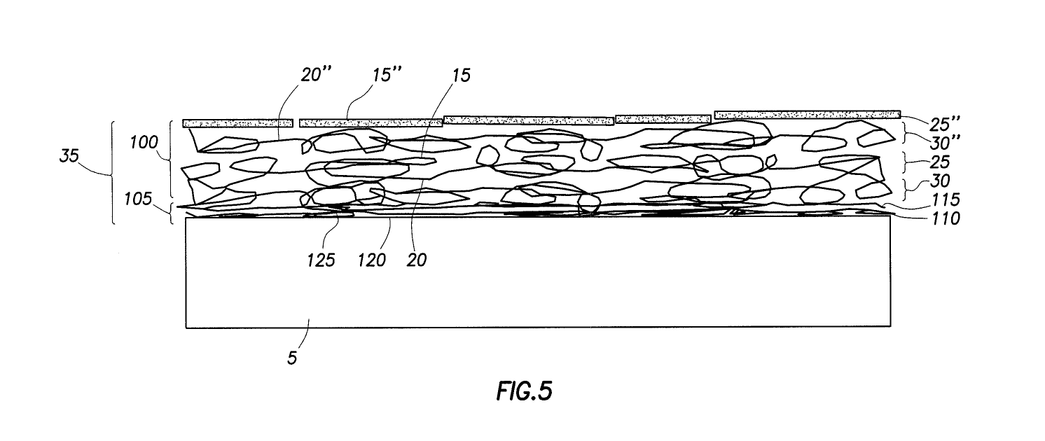

It is to be further understood that coating 35 is not limited to one layerable material 15 but may include more than one layerable material 15 and/or more than one cationic material 20. The different layerable materials 15 may be disposed on the same anionic layer 25, alternating anionic layers 25, or in layers of bilayers 10, layers of quadlayers 100, layers of trilayers, and the like. The different cationic materials 20 may be dispersed on the same cationic layer 30 or in alternating cationic layers 30. For instance, in embodiments as illustrated in FIGS. 2-4, coating 35 includes two types of layerable materials 15, 15′ (i.e., sodium montmorillonite is layerable material 15 and ammonium polyphosphate is layerable material 15′). It is to be understood that substrate 5 is not shown for illustrative purposes only in FIGS. 2-4. FIG. 2 illustrates an embodiment in which layerable materials 15, 15′ are in different layers of bilayers 10. For instance, as shown in FIG. 2, layerable materials 15′ are deposited in the top bilayers 10 after layerable materials 15 are deposited on substrate 5 (not illustrated). FIG. 3 illustrates an embodiment in which coating 35 has layerable materials 15, 15′ in alternating bilayers. It is to be understood that cationic materials 20 are not shown for illustrative purposes only in FIG. 3. FIG. 4 illustrates an embodiment in which there are two types of bilayers 10, comprised of particles (layerable materials 15, 15′) and cationic materials 20, 20′ (e.g., polymers).

In some embodiments, the multilayer thin film coating method includes rinsing substrate 5 between each exposure step (i.e., step of exposing to cationic mixture or step of exposing to anionic mixture). For instance, after substrate 5 is removed from exposure to the cationic mixture, substrate 5 with cationic layer 30 is rinsed and then exposed to an anionic mixture. After exposure to the anionic mixture, substrate 5 with bilayer 10, trilayer, quadlayer 100 or the like is rinsed before exposure to the same or another cationic mixture. The rinsing is accomplished by any rinsing liquid suitable for removing all or a portion of excess polyelectrolyte (or charged particles) from substrate 5 and any layer. In embodiments, the rinsing liquid includes deionized water, methanol, or any combinations thereof. In an embodiment, the rinsing liquid is deionized water. Substrate 5 may be rinsed for any suitable period of time to remove all or a portion of excess polyelectrolyte (or charged particles). In an embodiment, substrate 5 is rinsed for a period of time from about 5 seconds to about 5 minutes. In some embodiments, substrate 5 is rinsed after a portion of the exposure steps.

In embodiments, the multilayer thin film coating method includes drying substrate 5 between each exposure step (i.e., step of exposing to cationic mixture or step of exposing to anionic mixture). For instance, after substrate 5 is removed from exposure to the cationic mixture, substrate 5 with cationic layer 30 is dried and then exposed to an anionic mixture. After exposure to the anionic mixture, substrate 5 with bilayer 10, trilayer, quadlayer 100, or the like is dried before exposure to the same or another cationic mixture. The drying is accomplished by applying a drying gas to substrate 5. The drying gas may include any gas suitable for removing all or a portion of liquid from substrate 5. In embodiments, the drying gas includes air, nitrogen, or any combinations thereof. In an embodiment, the drying gas is air. In some embodiments, the air is filtered air. Substrate 5 may be dried for any suitable period of time to remove all or a portion of the liquid. In an embodiment, substrate 5 is dried for a period of time from about 5 seconds to about 500 seconds. In an embodiment in which substrate 5 is rinsed after an exposure step, substrate 5 is dried after rinsing and before exposure to the next exposure step. In alternative embodiments, drying includes applying a heat source to substrate 5. For instance, in an embodiment, substrate 5 is disposed in an oven for a time sufficient to remove all or a portion of the liquid. In alternative embodiments, drying includes squeezing substrate 5 to wring the liquid out. In some embodiments, drying is not performed until all layers have been deposited, as a final step before use.

In some embodiments (not illustrated), additives may be added to coating 35. In embodiments, the additives may be mixed in anionic mixtures with layerable materials 15. In other embodiments, the additives are disposed in anionic mixtures that do not include layerable materials 15. In some embodiments, coating 35 has a layer or layers of additives. In embodiments, the additives are anionic materials. The additives may also be added in cationic mixtures with cationic materials 20. The additives may be used for any desirable purpose. For instance, additives may be used for protection of substrate 5 against ultraviolet light or for abrasion resistance. For ultraviolet light protection, any negatively charged material suitable for protection against ultraviolet light and for use in coating 35 may be used. In an embodiment, examples of suitable additives for ultraviolet protection include titanium dioxide, or any combinations thereof. In embodiments, the additive is titanium dioxide. For abrasion resistance, any additive suitable for abrasion resistance and for use in coating 35 may be used. In embodiments, examples of suitable additives for abrasion resistance include crosslinkers. Crosslinkers may be any chemical that reacts with any matter in coating 35. Examples of crosslinkers include bromoalkanes, aldehydes, carbodiimides, amine active esters, or any combinations thereof. In embodiments, the aldehydes include glutaraldehyde. In an embodiment, the carbodiimide is 1-ethyl-3-(3-dimethylaminopropyl) carbodiimide (EDC). Embodiments include the amine reactive esters including N-hydroxysuccinimide esters, imidoesters, or any combinations thereof. The crosslinkers may be used to crosslink the anionic layers 25 and/or cationic layers 30. In an embodiment, substrate 5 with layers (i.e., bilayer 10, trilayer, quadlayer 100, or the like) is exposed to additives in an anionic mixture in the last exposure step (i.e., final bath or final spray step). In alternative embodiments, the additives may be added in an exposure step. Without limitation, crosslinking provides washability and durability to coating 35.

In some embodiments, the pH of anionic and/or cationic solution is adjusted. Without being limited by theory, reducing the pH of the cationic solution reduces growth of coating 35. Further, without being limited by theory, the coating 35 growth may be reduced because the cationic solution may have a high charge density at lowered pH values, which may cause the polymer backbone to repel itself into a flattened state. In some embodiments, the pH is increased to increase the coating 35 growth and produce a thicker coating 35. Without being limited by theory, a lower charge density in the cationic mixture provides an increased coiled polymer. The pH may be adjusted by any suitable means such as by adding an acid or base.

The exposure steps in the anionic and cationic mixtures may occur at any suitable temperature. In an embodiment, the exposure steps occur at ambient temperatures. In some embodiments, the fire retardant coating is optically transparent.

The layers may be in any desired configuration such as a trilayer disposed on a bilayer 10, a quadlayer 100 disposed on a trilayer that is disposed on a bilayer 10, and the like. In addition, in some embodiments, layerable materials 15 and/or cationic materials 20 in a layer (i.e., a bilayer 10) are different than layerable materials 15 and/or cationic materials 20 in a proximate layer (i.e., a quadlayer 100). Without being limited by theory, coatings 35 that have a layer with different layerable materials 15 and/or cationic materials 20 than a proximate layer may have a synergistic effect. Such synergistic effect may increase the flame retardancy of coating 35. For instance, in embodiments, a cationic layer 30 has layers that do not include clay but in one layer or other layers, clay is used as the cationic material 20.

Without being limited by theory, the fire retardant coating covers the internal walls of the pores of the substrate without blocking the pores. For instance, in an embodiment in which the substrate is a fabric comprising threads, the multilayer thin film coating method may individually coat each thread with the fire retardant coating. Further, without being limited by theory, coating each thread provides flame retardancy to the substrate but allows the threads to remain soft and flexible.

Although the present disclosure and its advantages have been described in detail, it should be understood that various changes, substitutions and alterations may be made herein without departing from the spirit and scope of the disclosure as defined by the appended claims.

What is claimed is:

1. A method for coating a substrate to provide a flame resistant substrate, comprising:
(A) exposing the substrate to a cationic solution to produce a cationic layer deposited on the substrate, wherein the cationic solution comprises cationic materials, and wherein the cationic materials comprise a melamine; and
(B) exposing the cationic layer to an anionic solution to produce an anionic layer deposited on the cationic layer to produce a layer comprising the anionic layer and the cationic layer, wherein the anionic solution comprises a phosphated molecule.

2. The method of claim 1, wherein the melamine comprises a melamine salt, a melamine hydrochloric acid, or any combinations thereof.

3. The method of claim 2, wherein the melamine salt comprises a melamine acetate, a melamine monoacetate, a melamine hydrochloride, or any combinations thereof.

4. The method of claim 1, wherein the melamine comprises melamine hydrochloride.

5. The method of claim 1, wherein the phosphated molecule comprises a polysodium phosphate, an ammonium phosphate, an ammonium polyphosphate, a sodium hexametaphosphate, or any combinations thereof.

6. The method of claim 1, wherein the phosphated molecule comprises ammonium polyphosphate.

7. The method of claim 1, wherein the substrate comprises a primer layer.

8. The method of claim 1, further comprising exposing the anionic layer to a second cationic solution to produce a second cationic layer deposited on the anionic layer.

9. The method of claim 8, further comprising exposing the second cationic layer to a second anionic solution to produce a second anionic layer on the second cationic layer.

10. The method of claim 1, further comprising a crosslinker.

11. A method for coating a substrate to provide a flame resistant substrate, comprising:
(A) exposing the substrate to an anionic solution to produce an anionic layer deposited on the substrate, wherein the anionic solution comprises a phosphated molecule; and
(B) exposing the anionic layer to a cationic solution to produce a cationic layer deposited on the anionic layer to produce a layer comprising the anionic layer and the cationic layer, wherein the cationic solution comprises cationic materials, and wherein the cationic materials comprise a melamine.

12. The method of claim 11, wherein the melamine comprises a melamine salt, a melamine hydrochloric acid, or any combinations thereof.

13. The method of claim 12, wherein the melamine salt comprises a melamine acetate, a melamine monoacetate, a melamine hydrochloride, or any combinations thereof.

14. The method of claim 11, wherein the melamine comprises melamine hydrochloride.

15. The method of claim 11, wherein the phosphated molecule comprises a polysodium phosphate, an ammonium phosphate, an ammonium polyphosphate, a sodium hexametaphosphate, or any combinations thereof.

16. The method of claim 11, wherein the phosphated molecule comprises ammonium polyphosphate.

17. The method of claim 11, wherein the substrate comprises a primer layer.

18. The method of claim 11, further comprising exposing the cationic layer to a second anionic solution to produce a second anionic layer deposited on the cationic layer.

19. The method of claim 18, further comprising exposing the second anionic layer to a second cationic solution to produce a second cationic layer on the second anionic layer.

20. The method of claim 11, further comprising a crosslinker.
